(19) United States
(12) Patent Application Publication
(10) Pub. No.: US 2024/0332500 A1
(43) Pub. Date: Oct. 3, 2024

(54) POSITIVE ELECTRODE AND ALL-SOLID-STATE BATTERY

(71) Applicant: HONDA MOTOR CO., LTD., Tokyo (JP)

(72) Inventors: Kiyoshi Tanaami, Wako-shi (JP); Toshimitsu Tanaka, Wako-shi (JP)

(21) Appl. No.: 18/588,009

(22) Filed: Feb. 27, 2024

(30) Foreign Application Priority Data
Mar. 29, 2023 (CN) 202310326174.6

(51) Int. Cl. H01M 4/36; H01M 4/02; H01M 4/04; H01M 10/0562

(52) U.S. Cl. CPC H01M 4/364; H01M 4/0404; H01M 10/0562; H01M 2004/021; H01M 2004/028; H01M 2300/0068

(57) ABSTRACT

A positive electrode includes a metal porous body, a positive electrode mixture containing a positive electrode active material loaded into the metal porous body and a current collection part connected to the metal porous body, and the metal porous body has a region with a porosity of less than 60%.

### CROSS-REFERENCE TO RELATED APPLICATION

Priority is claimed on Chinese Patent Application No. 202310326174.6, filed Mar. 29, 2023, the content of which is incorporated herein by reference.

### BACKGROUND OF THE INVENTION

### Field of the Invention

The present invention relates to a positive electrode and an all-solid-state battery including the positive electrode.

### Description of Related Art

A positive electrode of a battery can be obtained by, for example, applying an electrode mixture onto a positive electrode current collector to form a positive electrode active material layer.

In a case where the aspect ratio of a positive electrode (the ratio of the length to width of the positive electrode) is large, if the distance from a current collection part connected to one end face of a positive electrode current collector in the length direction becomes large, a variation in the current distribution is caused on a surface of the positive electrode in contact with a solid electrolyte layer. The variation in the current distribution causes a variation in ion conduction. When a variation is caused in the ion conduction, another variation is also caused in the battery reaction. The variation in the battery reaction becomes significant particularly when a large current with a high rate flows in the positive electrode or a battery is rapidly charged.

When a charge/discharge cycle is repeated in a battery including a positive electrode having a large variation in the current distribution as described above, the influence on resistance deterioration increases, the deterioration of the positive electrode is accelerated and the battery performance becomes insufficient. Particularly, in a battery where a reaction is promoted by contact between solids, since there is no flow of the solid electrolyte layer, the deterioration of the positive electrode is assumed to be more significant.

In addition, an electrode for a battery in which the density of a current collector varies with places is known (for example, refer to Patent Documents 1 and 2). In an electrode including a current collector the density of which varies with places as described above, a variation is also caused in the above-described battery reaction.

In addition, in a case where silicon is used as a positive electrode active material, a structural deterioration such as cracking occurs in an electrode mixture layer due to charge/discharge-induced expansion and contraction or a rupture or the like occurs in a positive electrode current collector, which makes an electronic path rupture more significantly. As a result, a capacity deterioration and a resistance deterioration occur, and the function as a battery significantly deteriorates.

Furthermore, even in an electrode for which a metal porous body is used, in a case where the aspect ratio is large, the stress of expansion and contraction becomes uneven in the plane, the metal porous body stretches depending on the situation, the stretch or partial rupture of a metal fiber occurs to rupture an electronic path, and a capacity deterioration and a resistance deterioration occur.

### PATENT DOCUMENTS

[Patent Document 1] Japanese Unexamined Patent Application, First Publication No. 2011-175934
[Patent Document 2] Japanese Unexamined Patent Application, First Publication No. 2011-154979

### SUMMARY OF THE INVENTION

The present application is intended to curb the stretch of a positive electrode including a metal porous body to solve the above-described problems. In addition, the present application, furthermore, contributes to an increase in the energy efficiency.

In order to achieve the above-described objectives, the present invention provides the following means.

[1] A positive electrode including a metal porous body, a positive electrode mixture containing a positive electrode active material loaded into the metal porous body and a current collection part connected to the metal porous body,
in which the metal porous body has a region with a porosity of less than 60%.

In the positive electrode of the present invention, since the metal porous body has a region with a porosity of less than 60%, it is possible to curb the stretch of the positive electrode. Therefore, it is possible to curb the occurrence of a capacity deterioration and a resistance deterioration in the positive electrode due to the occurrence of a structural deterioration such as cracking in the metal porous body.

[2] The positive electrode according to [1], in which the region is disposed along at least one of a length direction and a width direction of the metal porous body.

Since the region is disposed along at least one of the length direction and the width direction of the metal porous body, it is possible to curb the stretch of the positive electrode.

[3] The positive electrode according to [1], in which the region is composed of a first region disposed along a length direction of the metal porous body and a second region disposed along a width direction of the metal porous body, and the first region and the second region are disposed so as to be orthogonal to each other.

Since the region is composed of the first region disposed along the length direction of the metal porous body and the second region disposed along the width direction of the metal porous body, and the first region and the second region are disposed so as to be orthogonal to each other, it is possible to curb the stretch of the positive electrode.

[4] The positive electrode according to [1], in which the region is composed of a plurality of regions disposed at equal intervals along a width direction of the metal porous body, and the plurality of regions is disposed parallel to one another.

Since the region is composed of a plurality of regions disposed at equal intervals along the width direction of the metal porous body, and the plurality of regions is disposed parallel to one another, it is possible to curb the stretch of the positive electrode.

[5] The positive electrode according to [1], in which the region is composed of a first region and a second region disposed so as to be in contact with each of two side surfaces along a length direction of the metal porous body and a third region disposed so as to be in contact with one side surface along a width direction of the metal porous body.

Since the region is composed of the first region and the second region disposed so as to be in contact with each of the two side surfaces along the length direction of the metal porous body and the third region disposed so as to be in contact with one side surface along the width direction of the metal porous body, it is possible to curb the stretch of the positive electrode.

[6] The positive electrode according to [1], in which the region is disposed in the metal porous body concentrically with the metal porous body and has an annular shape similar to a shape of the metal porous body.

Since the region is disposed in the metal porous body concentrically with the metal porous body and has an annular shape similar to a shape of the metal porous body, it is possible to curb the stretch of the positive electrode.

[7] An all-solid-state battery including:
the positive electrode according to any one of [1] to [6],
a negative electrode having a negative electrode active material layer formed on a negative electrode current collector, and
a solid electrolyte layer disposed between the positive electrode and the negative electrode.

The battery of the present invention is an all-solid-state battery, and since the battery includes the positive electrode of the present invention, deterioration is curbed, and the service life becomes long.

According to the present invention, it is possible to curb the stretch of the positive electrode including the metal porous body.

### BRIEF DESCRIPTION OF THE DRAWINGS

FIG. 1 is a perspective view showing a first embodiment of a positive electrode according to an embodiment of the present invention.

FIG. 2 is a perspective view showing the first embodiment of the positive electrode according to the embodiment of the present invention.

FIG. 3 is a perspective view showing a second embodiment of the positive electrode according to the embodiment of the present invention.

FIG. 4 is a perspective view showing the second embodiment of the positive electrode according to the embodiment of the present invention.

FIG. 5 is a perspective view showing a third embodiment of the positive electrode according to the embodiment of the present invention.

FIG. 6 is a perspective view showing the third embodiment of the positive electrode according to the embodiment of the present invention.

FIG. 7 is a perspective view showing a fourth embodiment of the positive electrode according to the embodiment of the present invention.

FIG. 8 is a perspective view showing the fourth embodiment of the positive electrode according to the embodiment of the present invention.

### DETAILED DESCRIPTION OF THE INVENTION

Hereinafter, an embodiment of the present invention will be described in detail.

### [Positive Electrode]

### First Embodiment

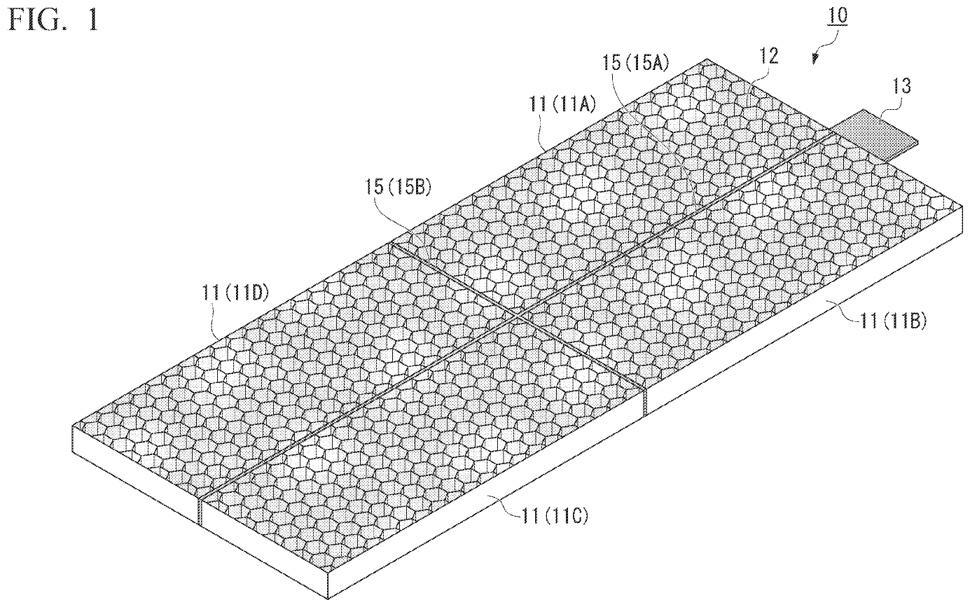

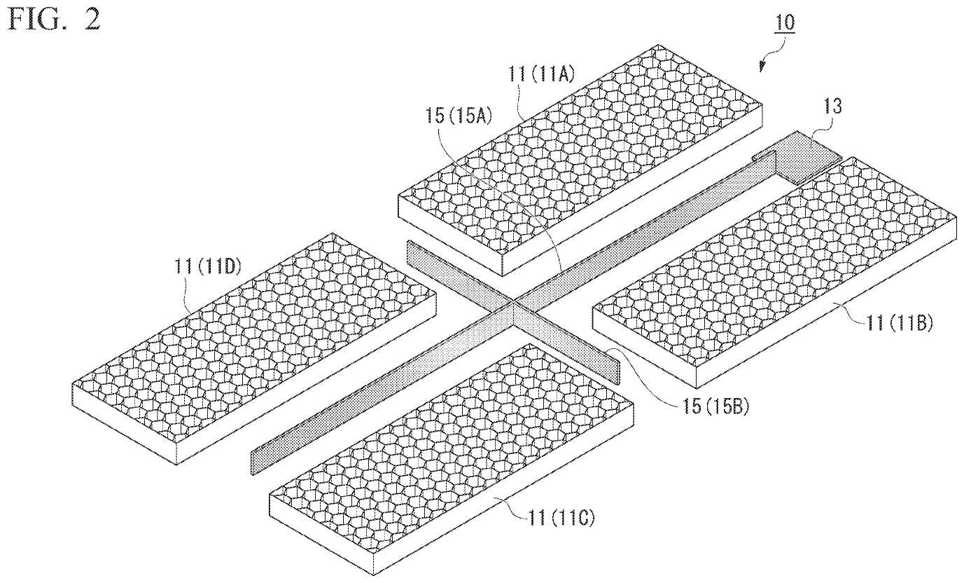

FIG. 1 and FIG. 2 are perspective views showing a first embodiment of a positive electrode according to the embodiment of the present invention. In the drawings to be used in the following description, there will be cases where a characteristic part is enlarged for convenience to facilitate the understanding of the characteristic, and the dimensional ratio and the like of each configuration element are not limited to those shown in the drawings.

A positive electrode 10 of the present embodiment includes a metal porous body 11, a positive electrode mixture 12 containing a positive electrode active material loaded into the metal porous body 11 and a current collection part 13 connected to the metal porous body 11. The metal porous body 11 has a region 15 with a porosity of less than 60%.

In the present embodiment, the region 15 is composed of a first region 15A disposed along a length direction of the metal porous body 11 and a second region 15B disposed along a width direction of the metal porous body 11. The first region 15A is disposed so as to pass through a central line in the length direction of the metal porous body 11. The second region 15B is disposed so as to pass through a central line in the width direction of the metal porous body 11. The first region 15A and the second region 15B are disposed so as to be orthogonal to each other.

The metal porous body 11 is divided into four portions 11A, 11B, 11C and 11D by the first region 15A and the second region 15B.

The metal porous body 11 is a metal porous body including a large number of pores (fine holes) like a resin sponge. Examples of a metal material of the metal porous body 11 include foamed aluminum and the like that are manufactured by adding a foaming agent to a molten metal. The porosity of the metal porous body 11 is 60% or more.

The positive electrode mixture 12 contains a positive electrode active material that gives and receives lithium ions and electrons. The positive electrode active material is not particularly limited as long as a material is capable of reversibly absorbing and desorbing lithium ions and is capable of electron transport, and a well-known positive electrode active material that can be applied to positive electrodes in all-solid-state lithium ion batteries can be used. Examples thereof include composite oxides such as lithium cobalt oxide (LiCoO₂), lithium nickel oxide (LiNiO₂), lithium manganese oxide (LiMn₂O₄), solid solution oxides (Li₂MnO₃-LiMO₂ (M=Co, Ni or the like)), lithium-manganese-nickel-cobalt oxides (LiNiₓMn_{y}Co_{z}O₂, x+y+z=1), olivine-type lithium phosphate (LiFePO₄); conductive polymers such as polyaniline and polypyrrole; sulfides such as Li₂S, CuS, Li—Cu—S compounds, TiS₂, FeS, MoS₂ and Li—Mo—S compounds; mixtures of sulfur and carbon; and the like. The positive electrode active material may be composed of one of the above-listed materials alone or may be composed of two or more thereof.

The positive electrode mixture 12 may contain an auxiliary conductive agent from the viewpoint of improving the conductivity of the positive electrode 10. As the auxiliary conductive agent, an auxiliary conductive agent that can be ordinarily used in all-solid-state lithium ion batteries can be used. Examples thereof include carbon black such as acetylene black and ketjen black; carbon fibers; vapor-grown carbon fibers; graphite powders; and carbon materials such as carbon nanotubes. The auxiliary conductive agent may be composed of one of the above-listed materials alone or may be composed of two or more thereof.

In addition, the positive electrode mixture 12 may also contain a binder having a role of binding the positive electrode active materials and the positive electrode active material and the metal porous body 11.

The region 15 has, for example, a band shape. The region 15 is not particularly limited, and examples thereof include metal foils, metal plates and the like that are composed of the same metal as the metal configuring the metal porous body 11.

According to the positive electrode 10 of the present embodiment, since the region 15 is composed of the first region 15A disposed along the length direction of the metal porous body 11 and the second region 15B disposed along the width direction of the metal porous body 11, and the first region 15A and the second region 15B are disposed so as to be orthogonal to each other, it is possible to curb the stretch of the positive electrode 10. Therefore, it is possible to curb the occurrence of a capacity deterioration and a resistance deterioration in the positive electrode 10 due to the occurrence of a structural deterioration such as cracking in the metal porous body 11.

### Second Embodiment

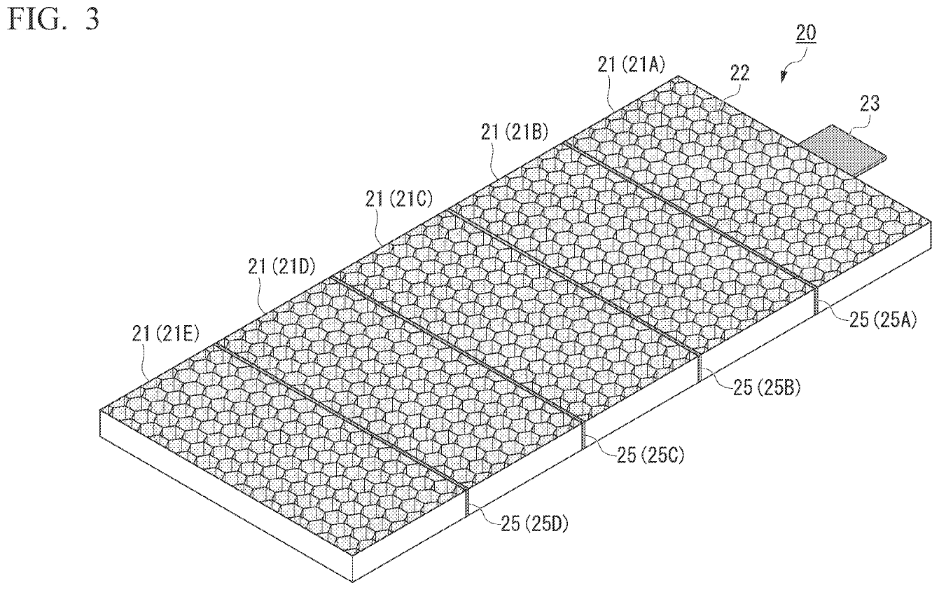

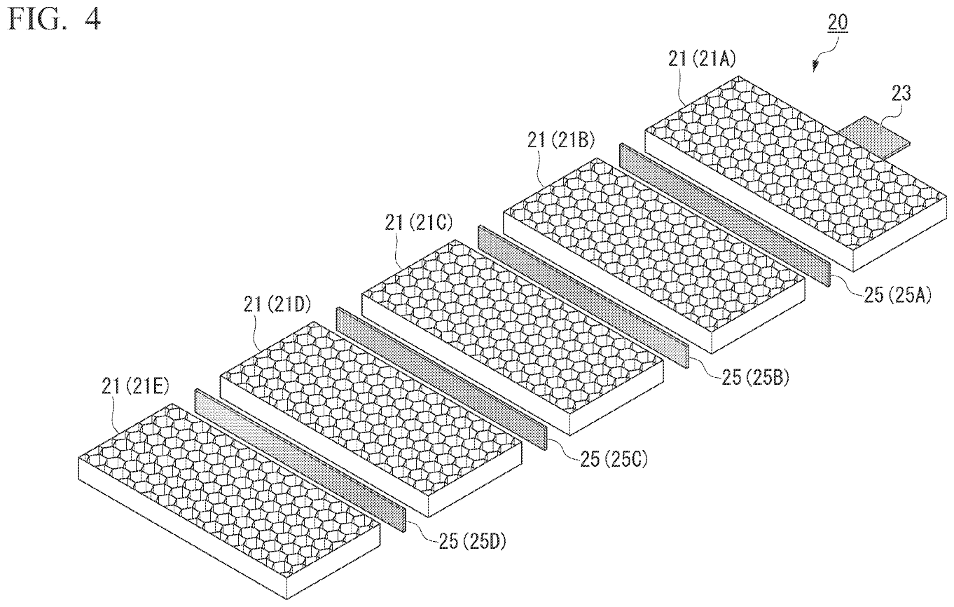

FIG. 3 and FIG. 4 are perspective views showing a second embodiment of the positive electrode according to the embodiment of the present invention.

A positive electrode 20 of the present embodiment includes a metal porous body 21, a positive electrode mixture 22 containing a positive electrode active material loaded into the metal porous body 21 and a current collection part 23 connected to the metal porous body 21. The metal porous body 21 has a region 25 with a porosity of less than 60%. The region 25 has, for example, a band shape.

In the present embodiment, the region 25 is composed of a first region 25A, a second region 25B, a third region 25C and a fourth region 25D disposed at equal intervals along a width direction of the metal porous body 21. The first region 25A, the second region 25B, the third region 25C and the fourth region 25D are disposed parallel to one another.

The metal porous body 21 is divided into five portions 21A, 21B, 21C, 21D and 21E by the first region 25A, the second region 25B, the third region 25C and the fourth region 25D.

As the positive electrode mixture 22 and the metal porous body 21, the same materials as those in the first embodiment can be used.

According to the positive electrode 20 of the present embodiment, since the region 25 is composed of the first region 25A, the second region 25B, the third region 25C and the fourth region 25D disposed at equal intervals along the width direction of the metal porous body 21, and the first region 25A, the second region 25B, the third region 25C and the fourth region 25D are disposed parallel to one another, it is possible to curb the stretch of the positive electrode 20. Therefore, it is possible to curb the occurrence of a capacity deterioration and a resistance deterioration in the positive electrode 20 due to the occurrence of a structural deterioration such as cracking in the metal porous body 21.

### Third Embodiment

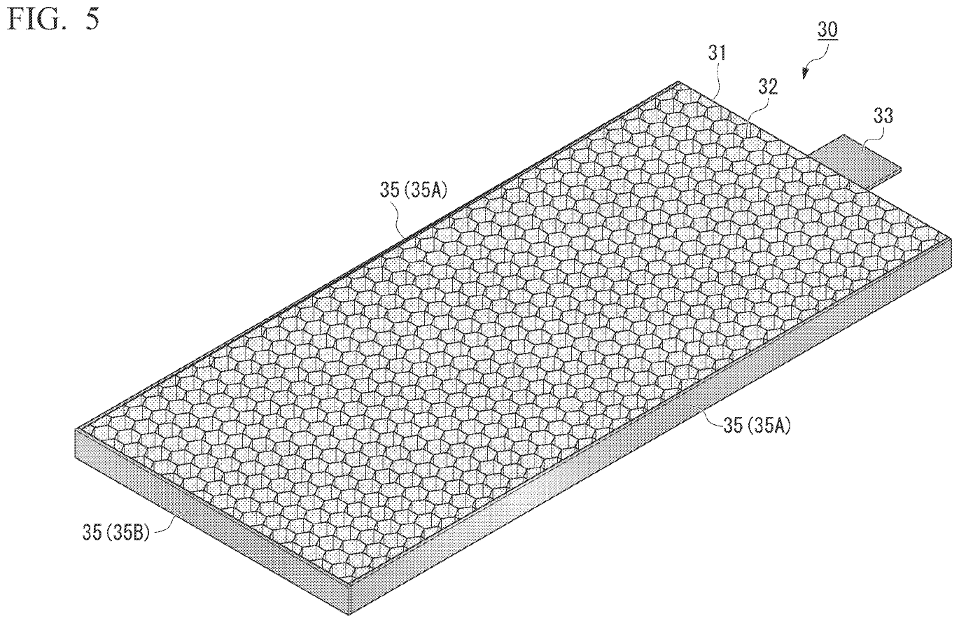

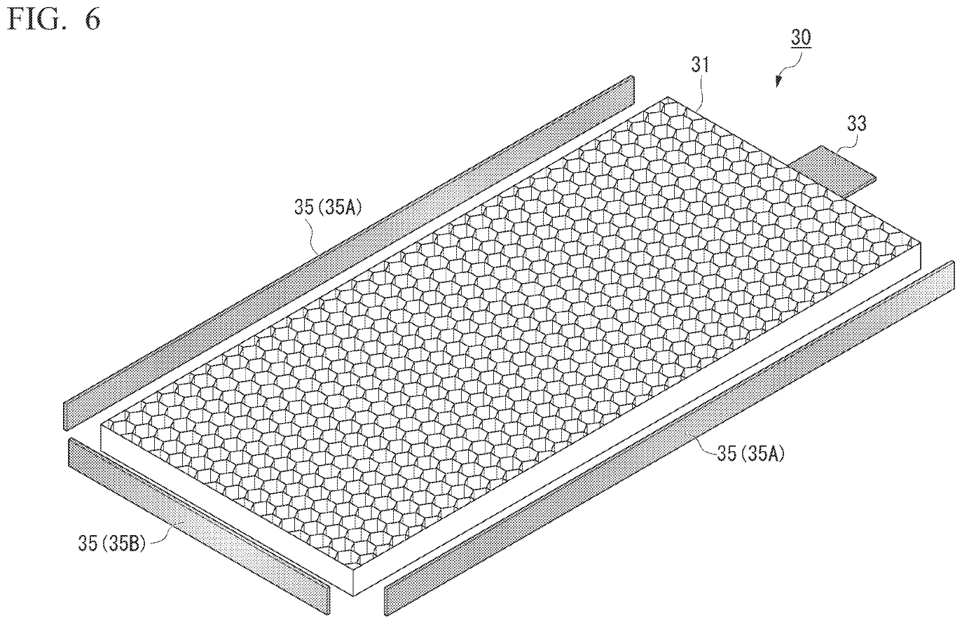

FIG. 5 and FIG. 6 are perspective views showing a third embodiment of the positive electrode according to the embodiment of the present invention.

A positive electrode 30 of the present embodiment includes a metal porous body 31, a positive electrode mixture 32 containing a positive electrode active material loaded into the metal porous body 31 and a current collection part 33 connected to the metal porous body 31. The metal porous body 31 has a region 35 with a porosity of less than 60%. The region 35 has, for example, a band shape.

In the present embodiment, the region 35 is composed of first regions 35A disposed so as to be in contact with two side surfaces along a length direction of the metal porous body 31 and a second region 35B disposed so as to be in contact with one side surface (a side surface not provided with the current collection part 33) along a width direction of the metal porous body 31. The first regions 35A and the second region 35B are disposed on the side surfaces adjacent to the metal porous body 31. Therefore, one end portions of the two first regions 35A are each connected to one end portion and the other end portion of one second region 35B. Therefore, the region 35 is disposed so as to be in contact with the three side surfaces adjacent to the metal porous body 31.

As the positive electrode mixture 32 and the metal porous body 31, the same materials as those in the first embodiment can be used.

According to the positive electrode 30 of the present embodiment, since the region 35 is composed of the first regions 35A disposed so as to be in contact with the two side surfaces along the length direction of the metal porous body 31 and the second region 35B disposed so as to be in contact with the one side surface along the width direction of the metal porous body 31, and the region 35 is disposed so as to be in contact with the three side surfaces adjacent to the metal porous body 31, it is possible to curb the stretch of the positive electrode 30. Therefore, it is possible to curb the occurrence of a capacity deterioration and a resistance deterioration in the positive electrode 30 due to the occurrence of a structural deterioration such as cracking in the metal porous body 31.

### Fourth Embodiment

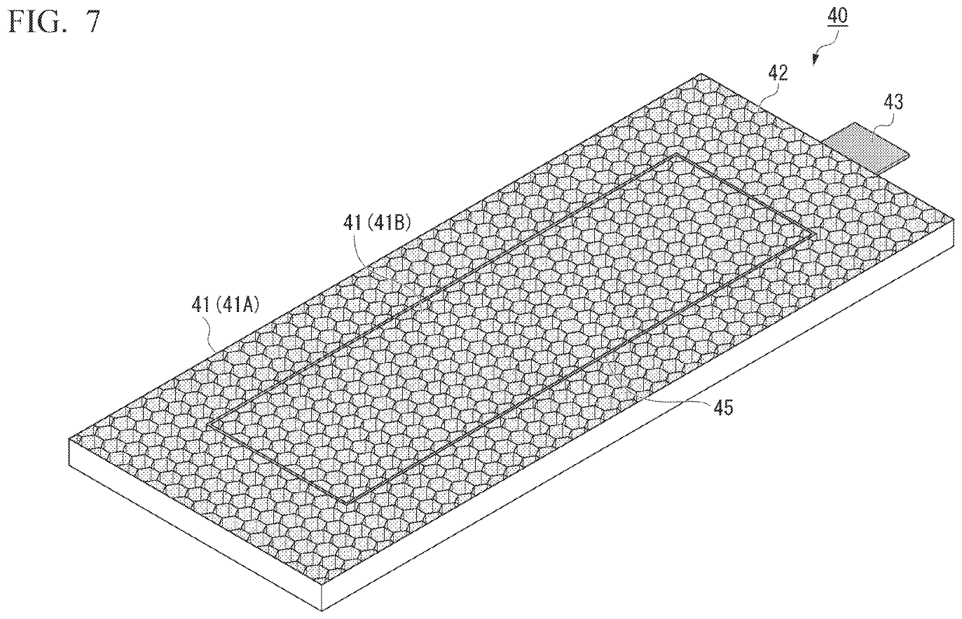

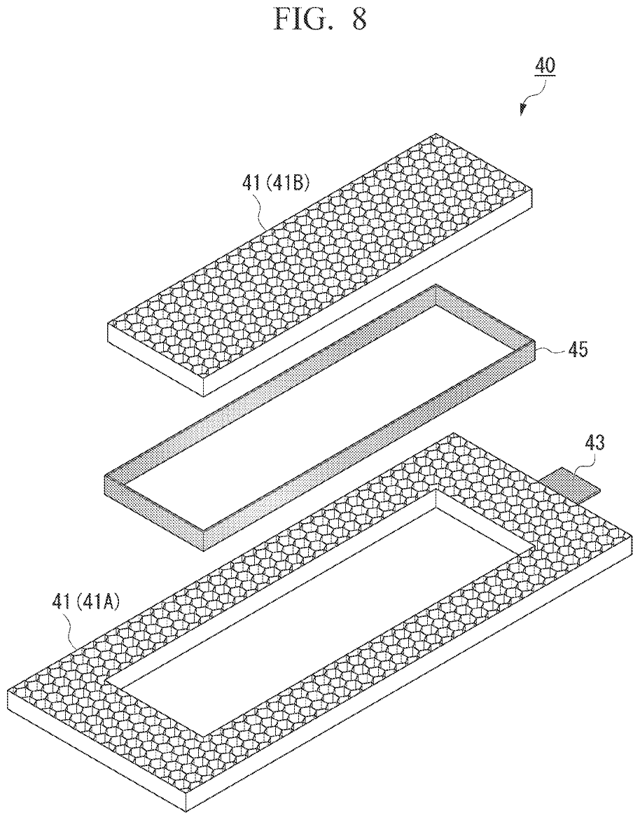

FIG. 7 and FIG. 8 are perspective views showing a fourth embodiment of the positive electrode according to the embodiment of the present invention.

A positive electrode 40 of the present embodiment includes a metal porous body 41, a positive electrode mixture 42 containing a positive electrode active material loaded into the metal porous body 41 and a current collection part 43 connected to the metal porous body 41. The metal porous body 41 has a region 45 with a porosity of less than 60%. The region 45 has, for example, a band shape.

In the present embodiment, the region 45 is disposed in the metal porous body 41 concentrically with the metal porous body 41 and has a square annular shape similar to a shape of the metal porous body 41.

The metal porous body 41 is divided into two portions 41A and 41B by the region 45. The portion 41A is a portion on the outside of the region 45. The portion 41B is a portion on the inside of the region 45.

As the positive electrode mixture 42 and the metal porous body 41, the same materials as those in the first embodiment can be used.

According to the positive electrode 40 of the present embodiment, since the region 45 is disposed in the metal porous body 41 concentrically with the metal porous body 41 and has a square annular shape similar to a shape of the metal porous body 41, it is possible to curb the stretch of the positive electrode 40. Therefore, it is possible to curb the occurrence of a capacity deterioration and a resistance deterioration in the positive electrode 40 due to the occurrence of a structural deterioration such as cracking in the metal porous body 41.

### [All-Solid-State Battery]

An all-solid-state battery includes, for example, the positive electrode 10 of the above-described first embodiment, a solid electrolyte layer and a negative electrode. In the all-solid-state battery, the positive electrode 10 and the negative electrode are laminated together across the solid electrolyte layer.

### (Solid Electrolyte Layer)

A solid electrolyte configuring the solid electrolyte layer is not particularly limited as long as the solid electrolyte has lithium ion conductivity and insulating properties, and materials that are ordinarily used in all-solid-state lithium ion batteries can be used. Examples thereof include sulfide solid electrolyte materials, oxide solid electrolyte materials, halide solid electrolytes, inorganic solid electrolytes such as lithium-containing salts, polymer-based solid electrolytes such as polyethylene oxide, gel-based solid electrolytes containing a lithium-containing salt or a lithium ion-conductive ionic liquid and the like. Among these, sulfide solid electrolyte materials are preferable from the viewpoint of high lithium ion-conduction characteristics and favorable structural formability or interfacial bondability by pressing.

The form of the solid electrolyte material is not particularly limited and can be, for example, particulate.

The solid electrolyte layer may contain a pressure-sensitive adhesive for imparting a mechanical strength or flexibility.

The solid electrolyte layer may have a sheet shape having a porous base material and a solid electrolyte held in the porous base material. The form of the porous base material is not particularly limited, and examples thereof include woven fabric, non-woven fabric, mesh cloth, porous films, expanded sheets, punched sheets and the like. Among these forms, non-woven fabric is preferable from the viewpoint of handleability by which the amount of the solid electrolyte loaded can be increased.

The porous base material may be composed of an insulating material. In such a case, it is possible to improve the insulating properties of the solid electrolyte layer. Examples of the insulating material include resin materials such as nylon, polyester, polyethylene, polypropylene, polytetrafluoroethylene, ethylene-tetrafluoroethylene copolymers, polyvinylidene fluoride, polyvinylidene chloride, polyvinyl chloride, polyurethane, vinylon, polybenzimidazole, polyimide, polyphenylene sulfite, polyether ether ketone, cellulose and acrylic resins; natural fibers such as hemp, wood pulp and cotton linters, glass and the like.

### (Negative Electrode)

The negative electrode has a negative electrode current collector and a negative electrode active material layer provided on the negative electrode current collector.

The negative electrode current collector is preferably composed of at least one substance having a high conductivity. Examples of the highly conductive substance include metals or alloys containing at least any one metal element of silver (Ag), palladium (Pd), gold (Au), platinum (Pt), aluminum (Al), copper (Cu), chromium (Cr) and nickel (Ni) and nonmetals such as carbon (C). When the manufacturing cost as well as the high conductivity is taken into account, copper, nickel or stainless steel is preferable. Furthermore, stainless steel is less likely to react with the positive electrode active material, the negative electrode active material and the solid electrolyte. Therefore, the use of stainless steel in the negative electrode current collector makes it possible to reduce the internal resistance of the all-solid-state battery.

As the shape of the negative electrode current collector, for example, a foil shape, a plate shape, a mesh shape, a non-woven fabric shape, a foam shape and the like can be exemplified. In addition, carbon or the like may be disposed on the surface of the negative electrode current collector or the surface may be roughened to enhance the adhesiveness to the negative electrode active material layer.

The negative electrode active material layer contains a negative electrode active material that gives and receives lithium ions and electrons. The negative electrode active material is not particularly limited as long as a material is capable of reversibly absorbing and desorbing lithium ions and is capable of electron transport, and a well-known negative electrode active material that can be applied to negative electrodes in all-solid-state lithium ion batteries can be used. Examples thereof include carbonaceous materials such as natural graphite, artificial graphite, resin charcoal, carbon fibers, activated carbon, hard carbon and soft carbon; alloy-based materials mainly containing tin, a tin alloy, silicon, a silicon alloy, gallium, a gallium alloy, indium, an indium alloy, aluminum, an aluminum alloy or the like; conductive polymers such as polyacene, polyacetylene and polypyrrole; metallic lithium, lithium alloys; lithium-titanium composite oxides (for example, Li₄Ti₅O₁₂) and the like. The negative electrode active material may be composed of one of the above-listed materials alone or may be composed of two or more thereof.

The negative electrode active material layer may contain an auxiliary conductive agent, a binder or the like. Materials thereof are not particularly limited, and, for example, the same materials as the materials that are used in the above-described positive electrode active material layer can be used.

According to the all-solid-state battery of the present embodiment, since the positive electrode 10 of the first embodiment is provided, the deterioration of the positive electrode 10 is curbed, and the service life of the all-solid-state battery becomes long.

Hitherto, the embodiment of the present invention has been described in detail, but the present invention is not limited to the embodiment and can be modified and changed in a variety of manners within the scope of the gist of the present invention described in the claims.

### EXPLANATION OF REFERENCES

10, 20, 30, 40 Positive electrode
11, 21, 31, 41 Metal porous body
12, 22, 32, 42 Positive electrode mixture
13, 23, 33, 43 Current collection part
15, 25, 35, 45 Region

What is claimed is:

1. A positive electrode comprising:
a metal porous body;
a positive electrode mixture containing a positive electrode active material loaded into the metal porous body; and
a current collection part connected to the metal porous body,
wherein the metal porous body has a region with a porosity of less than 60%.

2. The positive electrode according to claim 1,
wherein the region is disposed along at least one of a length direction and a width direction of the metal porous body.

3. The positive electrode according to claim 1,
wherein the region is composed of a first region disposed along a length direction of the metal porous body and a second region disposed along a width direction of the metal porous body, and the first region and the second region are disposed so as to be orthogonal to each other.

4. The positive electrode according to claim 1,
wherein the region is composed of a plurality of regions disposed at equal intervals along a width direction of the metal porous body, and the plurality of regions is disposed parallel to one another.

5. The positive electrode according to claim 1,
wherein the region is composed of a first region and a second region disposed so as to be in contact with each of two side surfaces along a length direction of the metal porous body and a third region disposed so as to be in contact with one side surface along a width direction of the metal porous body.

6. The positive electrode according to claim 1,
wherein the region is disposed in the metal porous body concentrically with the metal porous body and has an annular shape similar to a shape of the metal porous body.

7. An all-solid-state battery comprising:
the positive electrode according to claim 1;
a negative electrode having a negative electrode active material layer formed on a negative electrode current collector; and
a solid electrolyte layer disposed between the positive electrode and the negative electrode.
